(19) United States
(12) Patent Application Publication
(10) Pub. No.: US 2003/0226113 A1
(43) Pub. Date: Dec. 4, 2003

(54) Automatic page size setting

(75) Inventors: Dan William Altman, Kirkland, WA (US); Eric Fox, Seattle, WA (US); Steven Eliot Weil, Bellevue, WA (US); Marieke Iwema, Seattle, WA (US); Jitesh Vallabh, Redmond, WA (US)

Correspondence Address: BANNER & WITCOFF, 1001 G STREET N W, SUITE 1100, WASHINGTON, DC, 20001, US

(73) Assignee: Microsoft Corporation, Redmond, WA

(21) Appl. No.: 10/158,211

(22) Filed: May 31, 2002

(51) Int. Cl. G06F 15/00

(52) U.S. Cl. 715/520; 715/517

(57) ABSTRACT

A method and apparatus are provided for automatically setting a page size for an application based on a size of a display. An amount of work area on a display that is available to an application for data input is determined. A page size is set based on the available amount of the work area.

### FIELD OF THE INVENTION

The present invention relates in general to a user interface. More specifically, the present invention relates to setting a page size automatically based on the amount of available working space on a display.

### BACKGROUND OF THE INVENTION

Just as note takers wish to use all of the available working space on a sheet of paper for taking notes, users of a note taking, sketching, and diagramming application wish to fill all of the available working space of a display with ‘electronic paper’. Electronic paper is a region on a display in which a user can lay down electronic ink that will persist as part of a file. Typically, these applications set the aspect ratio of an electronic page based on real world printer pages. That is, the page size is based on a size of the papers that the printer is capable of printing (for example, letter, A4, legal, and the like). Some applications abandon the notion of ‘pages’ altogether and present the user with an ink-able ‘page’ which is an infinite plane in all directions. This gives the user all the advantages of filling all of the available working space with ink-able paper, but prevents them from taking advantage of pages as organizational and navigational units.

It is impossible to simultaneously fill all of the available working space of a display with an inkable surface and display entire pages one at a time unless the aspect ratio of the printed pages and the available working space on the computer display are the same. For example, FIGS. 3A through 3D show a screen, represented by thick lines, and pages, represented by thin lines.

In FIG. 3A, a page 301 is shown as the area surrounded on three sides by thin lines, as well as the area under the portion surrounded by thick lines. The screen 302 is shown as the area surrounded by the thick lines. As one can see, only a portion of the page is visible on the screen at a single time.

In FIG. 3B, the screen 302 can display a full page and a fraction of a next page. For example, 304 refers to page 1 of the display and 306 refers to page 2 of the display. In the example shown in FIG. 3B, all of page 1 is visible on the screen 302, while only a portion of page 2 is visible on the screen 302.

In FIG. 3C, the screen 302 is vertically the same length as a page 305, but cannot display a full width of the page 305, therefore requiring, for example, horizontal scrolling in order to view the remaining portion of the page 305.

In FIG. 3D, the screen 302 can display a full width of a page, but because the screen length is longer than a page, a page plus a portion of the next page may be displayed. For example, FIG. 3D shows all of a first page 310 being visible on the screen, while only a small portion of a second page 312 is visible on the screen.

When taking notes, users like to organize their page in specific ways. For example, a user may put the names of people attending a meeting at the top of a page and may list action items and persons responsible for the action items at the bottom of a page. Further, a user may place notes pertaining to different aspects of topics on particular portions of a page. It would be desirable to have an electronic ink application for note taking, which includes the concept of pages such that the position of various items placed on the page is preserved regardless of the physical size of the screen, the settings of the hardware, the configuration of the system or the state of the application used to view or enter the notes at any given time.

### SUMMARY

The present invention addresses the above situation by setting a page size for a document based on a size of a display at the time the document is first created.

In a first aspect of the invention, a method is provided for determining an amount of work area on a display that is available to an application for data input. A page size is set based on the available amount of work area.

In a second aspect of the invention, a medium having machine-readable instructions recorded thereon is provided. When the instructions are executed by a processor, the instructions cause the processor to determine an amount of work area on a display that is available to an application for data input, and to set a page size based on the available amount of work area.

In a third aspect of the invention, a device is provided for automatically setting a page size for an application based on a size of a display. The device includes a work area determiner for determining a size of a work area of the display, and a subtractor for subtracting a size of an area used for application window adornments from the size of the work area of the display to determine an amount of work area on the display that is available to the application for data input. An application page size setter is provided for setting a page size based on the available amount of the work area.

### BRIEF DESCRIPTION OF THE DRAWINGS

The present invention is described with respect to the accompanying figures, in which like reference numerals identify like elements, and in which:

FIG. 1 is a schematic diagram of a general purpose computer that can be used to practice embodiments of the invention;

FIG. 2 diagrammatically depicts an exemplary tablet PC 201 that can be used in accordance with various aspects of the present invention;

FIGS. 3A-3D depict a relationship of the screen size to the page size;

FIG. 4 depicts a functional block diagram of an embodiment of the invention;

FIG. 5 depicts a functional block diagram of another embodiment of the invention;

FIG. 6 depicts a layout of a display in accordance with embodiments of the present invention;

FIGS. 7A and 7B show a flowchart relating to an embodiment the invention;

FIG. 8 is a flowchart that explains processing in a variation of the invention that allows a page size to be changed;

FIGS. 9-10 show an example of the variation of the invention in which changing a page size can be performed;

FIGS. 11-12 show an example of the variation of the invention in which changing a page size cannot be performed; and

FIG. 13 is a flowchart for another variation of the invention that changes the page size for new pages when a change in available workspace is made.

### DETAILED DESCRIPTION

The following describes several embodiments of the invention. First, definitions are provided for describing the embodiments of the invention. Next, a general purpose computer, which may include an embodiment of the invention, is described. Third, an embodiment of the invention included in a tablet PC is described. Finally, embodiments of the invention for automatically setting a page size are described.

Definitions

Electronic paper: A region or regions in which a user can lay down electronic ink that will be persisted. The electronic ink may be persisted as part of, for example, a file, database, or memory.

Electronic Ink: Electronic markings on a display device made by a user using an electronic writing device, such as a stylus, to give the appearance of writing on a surface of the display device. If using a pressure sensitive screen, the writing device could be non-electronic, such as a plastic stylus or even a user's finger. Using electronic ink, a user may appear to draw or write on electronic paper in a manner similar to writing with a pen on paper. Electronic ink may be used with any application. Some applications, for example, a note taking application, accept the electronic data as a primary part of the document. Other applications, such as a spreadsheet, could use electronic ink as a mark up or comment on the primary contents of the document. Such a mark up or comment in the other applications may be stored as part of the document, but may not be stored as part of the primary contents.

Available Working space: A portion of a screen not obscured by, for example, a system taskbar or by application desktop toolbars. In other words, the region in which an application can display electronic paper.

Page size: The aspect ratio, orientation, and/or estimated actual size, in inches, pixels, centimeters, and the like, on a monitor that displays the electronic paper.

General Purpose Computer

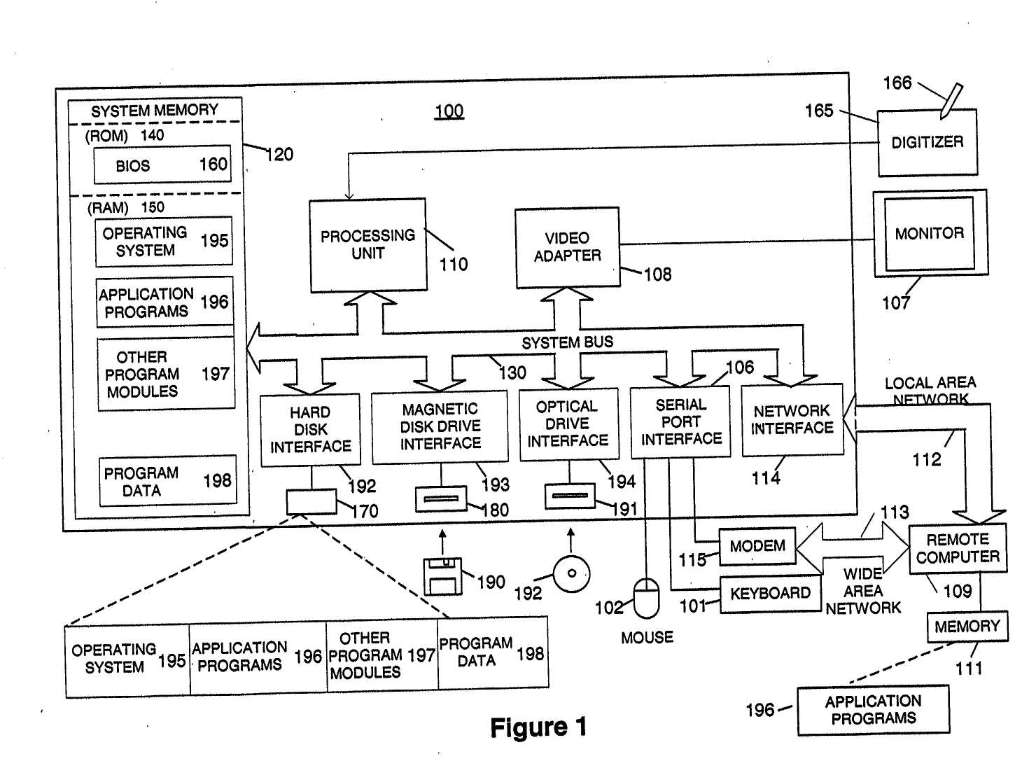

FIG. 1 illustrates a schematic diagram of an exemplary conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In a preferred embodiment, a pen digitizer 165 and accompanying pen or stylus 166 are provided in order to digitally capture freehand input. Although a direct connection between the pen digitizer 165 and the processing unit 110 is shown, in practice, the pen digitizer 165 may be coupled to the processing unit 110 via a serial port, parallel port or other interface and the system bus 130 as known in the art. Furthermore, although the digitizer 165 is shown apart from the monitor 107, it is preferred that the usable input area of the digitizer 165 be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are exemplary and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Tablet PC

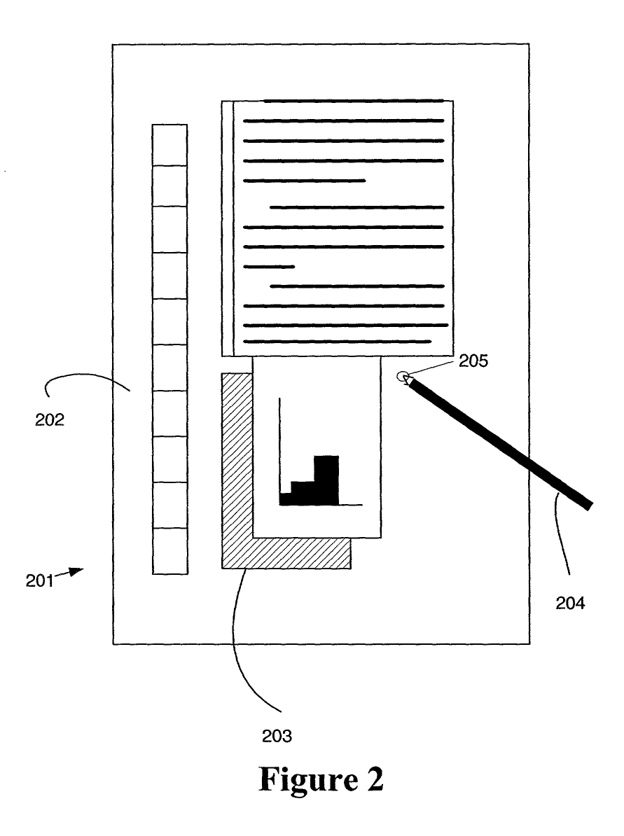

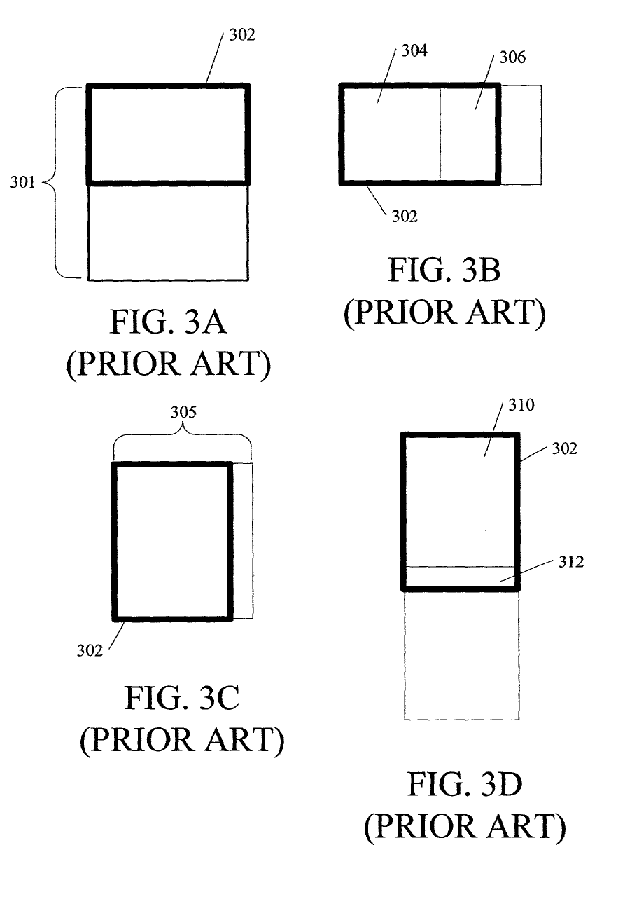

FIG. 2 illustrates an exemplary tablet PC 201 that can be used in accordance with various aspects of the present invention. Any or all of the features, subsystems, and functions in the system of FIG. 1 can be included in the computer of FIG. 2. Tablet PC 201 includes a large display surface or screen 202, e.g., a digitizing flat panel display, preferably, a liquid crystal display (LCD) screen, on which a plurality of windows 203 is displayed. Using stylus 204, a user can select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, may also be used. Tablet PC 201 interprets gestures made using stylus 204 in order to manipulate data, enter text, create drawings, and/or execute conventional computer application tasks such as spreadsheets, word processing programs, and the like.

The stylus 204 may be equipped with one or more buttons or other features to augment its selection capabilities. In one embodiment, the stylus 204 could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be the stylus 204 and used for selecting or indicating portions of the displayed image on a touch-sensitive or proximity-sensitive display. Consequently, the term “user input device”, as used herein, is intended to have a broad definition and encompasses many variations on well-known input devices such as stylus 204. Region 205 shows a feedback region or contact region permitting the user to determine where the stylus 204 has contacted the display surface 202.

Automatic Setting of Page Size

Embodiments of the present invention provide a method and apparatus by which the page size is automatically set based on the available data input area of a display, thereby allowing a user to take full advantage of the page as a grouping, sorting and organizing unit without giving up valuable screen real-estate (due to a page smaller than the screen size) or dealing with the inconvenience of excessive zooming & scrolling (due to a page larger than the screen size). Thus, the user may arrange a page in a particular way, for example, placing action items at the bottom, names of people attending a meeting at the top, or arranging to record data pertaining to different aspects on different portions of the page and have the entire arrangement of the page displayed. Four possible states of user interface elements should be considered in determining page size.

1. An item which is normally in view but currently hidden. For example a scroll bar on a new note. Space should be reserved for these items when setting the page size. (The page should be smaller than the total space currently available.)

2. An item which is normally hidden but currently in view. For example, a text input system (to be described later). The page size should be set to take advantage of the space that will be left behind when the text input system is closed. (The page should be larger than the space currently available.)

3. An item which is normally in view and is currently in view, but which is displayed inside a client region. For example, tool bars which are implemented in custom code, and hence may not taken into account by an application program interface (API) which returns the size of the client region. The space which this item occupies should be subtracted from the size of the client region before setting the page size. (The page should be smaller than the space currently reported as the client region.)

4. An item which is normally in view, currently in view and which is displayed outside the client region. For example the title bar, task bar, standard menus and tool bars. The API which returns the size of the client region may already account for these items, and if so, no further modifications to the page size need to occur for these items. (The page should match the space currently reported as the client region.)

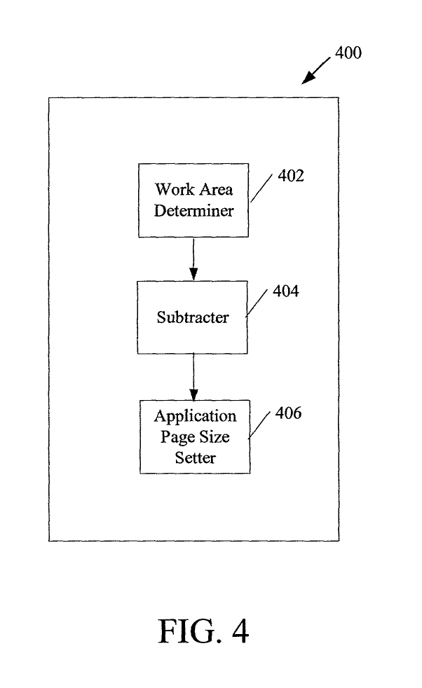

A functional block diagram of an embodiment of the invention is depicted in FIG. 4. The embodiment 400 includes a work area determiner 402 for determining an amount of an entire work area available to an application. The work area may be specified with the application's window maximized or by filling less than all of the screen 202. A subtractor 404 receives the amount of the entire work area available to the application and subtracts, from that area, application window adornments, such as tool bars and menus, when the application window adornments take up space that the determiner 402 reported as part of the work area available to an application. Thus, in this case, the space for the above application window adornments are not to be included as space that is part of the page. The subtraction is performed to determine an amount of the work area on the display that is available to the application for data input. If the space for the application window adornments was not included in the amount of available space reported by the determiner 402, then the subtractor 404 does not subtract the space for these window adornments.

An application page size setter 406 receives the amount of the work area on the display that is available to the application for data input and sets the page size based on this amount. In one aspect of the invention, the page size is the same for all pages within a file used by the application. Alternatively, in another aspect of the invention (to be described later) the page size may be set to match the available workspace size at the time the page is created. If the available workspace changes during the lifetime of the document, newer pages may be created with a page size set according to the then currently available workspace size.

Work area determiner 402, subtractor 404, and application page size setter 406 may be implemented in software, firmware or by an application specific integrated circuit (ASIC). The firmware may be in a read only memory and the software may reside on a medium, such as read only memory, random access memory, floppy disk or compact disk.

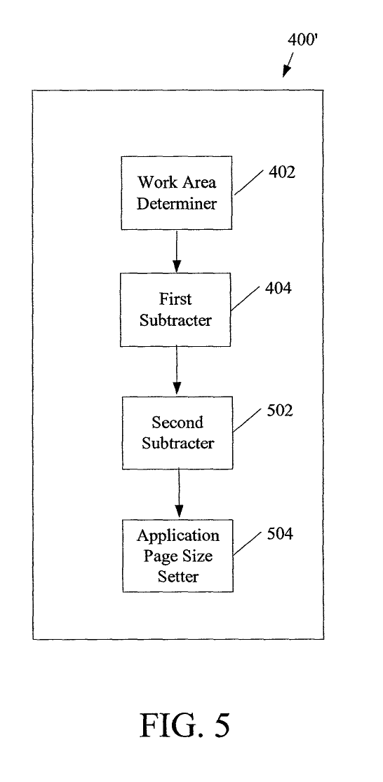

FIG. 5 illustrates a functional block diagram 400′ of another embodiment of the system. This embodiment includes work area determiner 402 and first subtractor 404, which are the same as work area determiner 402 and subtractor 404 shown in FIG. 4. Second subtractor 502 receives the amount of the entire work area available to an application less the size of areas used for application window adornments (as have been subtracted by subtractor 404), and a size of a scrolling element if a scrolling element is to be used, such as a vertical scrolling bar, and further subtracts the size of the scrolling element from the entire work area available to an application. Thus, an area will be reserved for the scrolling element and so the area for the scrolling element will not be considered part of the page.

Application page size setter 504 sets the page size based on the results of the second subtractor 402. A number of subtractors (404, 502) may be used to determine a page size as needed for multiple objects or other windows on the display screen 202. Alternatively, subtractor 404 may be used repeatedly to address the multiple objects or other windows.

Similar to work area determiner 402 and subtractor 404, second subtractor 502 and application page size setter 504 may be implemented in software, firmware, or ASIC.

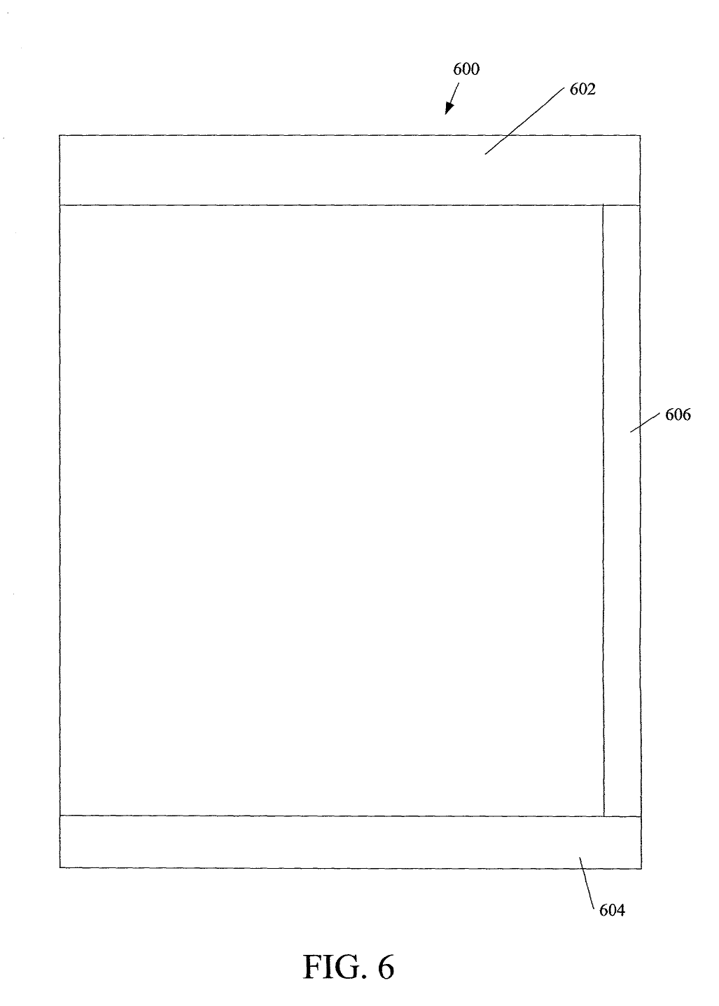

A layout of a display 600 is depicted in FIG. 6. Area 602 typically includes tool bars and menus. Area 604 typically includes a task bar showing the tasks currently executing. Area 606 is typically reserved for a vertical scrolling element. If areas 602, 604 and 606 are included in the available area reported by the determiner 402, the areas are subtracted from the available work area since a user will typically not enter data in these areas and ideally, a page equals one display screen worth of data. Alternatively, each of areas 602, 604, and 606 may be hidden or may appear at other portions of the page. For example, vertical scrolling element 606 or a tool bar may appear on the left side of the display. If the areas are hidden, it may be desirable to not include the space used by these areas as a limiting factor in setting the page size. Further, other areas, such as always on top windows, help windows, and auto-hide windows may not be included as a limiting factor because they are not normally shown during inking.

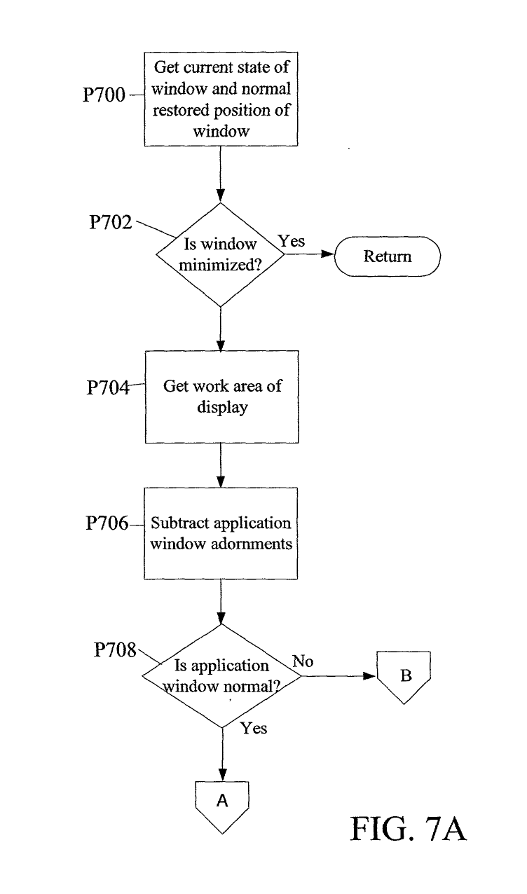

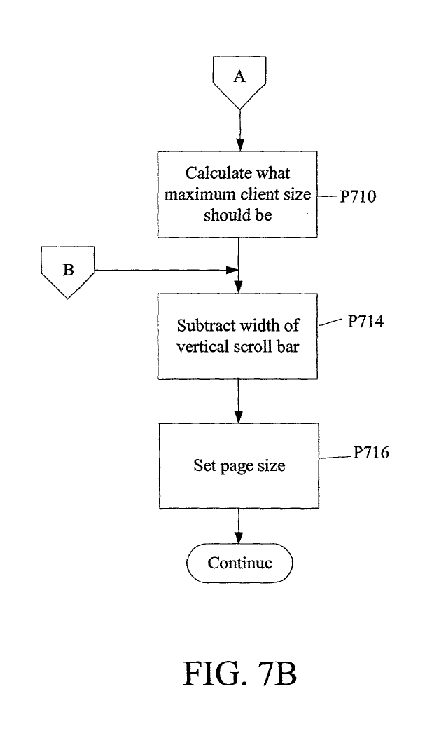

FIGS. 7A and 7B illustrate a method of determining and setting a page size in an embodiment of the invention. P700 through P704 are performed by work area determiner 402. At P700, the current state of the window and the normal restored position of the window are obtained. This can be performed in an embodiment of the invention, which uses a WIN32 application program interface (API), available from Microsoft Corporation of Redmond, Wash., by calling GetWindowPlacement.

The GetWindowPlacement method obtains the state and position information for a window. At P702, a check is made to determine whether the window is in a minimized state. If so, an automatic page size calculation will not be performed and is not needed while the window is in a minimized state. Alternatively, the calculation may be performed and the result held for future use. At P704, the size of a work area on a display on which the application is running is determined. In a WIN32 API environment, this can be done by using the MonitorFromRect method and the GetMonitorInfo methods. The result is the entire area available to applications in which they may display information. In other words, the area that an application may use in a window that has been sized to its maximum size.

At P706, subtractor 404 subtracts off an area used for the application window adornments (if any) that use space that was included in the amount of available space reported by determiner 402. In a WIN32 API environment, the amount of available space may be obtained by using the GetClientRect API, which returns space available to the client application (i.e., window adornments, such as tool bars, scroll bars and menus may not be included in the returned available space).

At P708, work area determiner 402 determines whether the application window is normal (i.e., non-maximized). If the application window is normal, then at P710, of FIG. 7B, work area determiner 402 determines what the maximized client size of the window should be. This may be accomplished by first determining the difference between the application window normal (non-maximized) area determined at P700 and the area determined at P706. This difference represents the area occupied by window adornments, for example, window title, tool bars and menu, as well as the application window border. This area occupied by the window adornments is then subtracted from the area of the display determined at P704. In addition, the amount of space used for a window border can be added to the work area because a maximized window does not have a border. In a WIN32 API environment, the amount of space used for a border may be retrieved using the GetSystemMetrics method. Thus, the area of the window having a maximum client size is determined.

If a determination at P708 is made that the application window is not normal (i.e., the window is in a maximized state), then P710 will not be performed.

At P714, an amount of space for a vertical scrolling element, such as a vertical scroll bar, is determined and subtracted from the previously determined area. Thus, space for the vertical scroll bar may not be provided to the user as available workspace. The width of the scroll bar may be obtained in a WIN32 API environment by the GetSystemMetrics method. This prevents the user from having to scroll horizontally after a vertical scroll bar appears on the display, which occurs after a user has, for example, created another page, opened an auxiliary view, or grafted a new tool bar to the top or bottom of an application window.

At P716, the determined area is then used to set the page size.

Alternatively, instead of performing a check at P708 to determine whether a non-maximized window size is being used and at P710, calculating what the maximum client size should be, the page size may be determined using the non-maximized window size. For example, if a user is reviewing a first document while reviewing or creating a second document, the user may want the window of the second document to be less than the maximum window size and thus, the page size of the pages of the second document may be determined using a window that is less than the maximum window size.

The above examples provide suggestions for performing the page size detemining calculations in a Win32 API environment; however, the invention is not limited to being used in such an environment. The invention may be used in any windowed environment or may be used in a non-windowed environment.

Many applications on handheld data input devices that lack a keyboard, use a text input system, to enter text into the applications. The text input system may be a keyboard display appearing on a portion of the screen. Typically, a user enters data by touching an appropriate key of the keyboard display with a stylus to enter a character corresponding to the key. In an application, such as a note taking application that allows a user to enter data using electronic ink, a user may prefer not to use a text input system as the user desires to enter handwritten notes. Therefore, in another embodiment of the invention, if a keyboard for a text input system appears on the screen, area used by the keyboard may be determined and added to the available area such that the area covered by the keyboard of the text input system is included in the page determining calculations. In an embodiment of the invention, subtractor 404 may be modified to include determining whether a keyboard of a text input system is visible on a display and adding an amount of the area of the keyboard text input system to the determined amount of the work area on the display that is available for data input, assuming that the text input system will be hidden or closed for the majority of note taking time. It is appreciated that the text input system may include other text entry systems as are known in the art, such as, for example, handwriting recognition.

The above-mentioned page size determining calculations of the embodiments may be performed as soon as an application, such as a note taking application, is opened, or may be performed as soon as a user begins to enter data into an application, such as the note taking application.

Further, in another embodiment of the invention, once the page size is set, as previously described, the page size may be reset after a user begins to enter information, provided that the changing of the page size will not affect the placement of the data on a page. For example, any inputted data will not be moved to another page and will not be placed at another position on the same page as a result of changing the page size. Thus, for example, if a single page of data is entered, the page size may be increased or decreased if none of the entered information will be moved to another page, another portion of the same page or become clipped or invisible using the new page size.

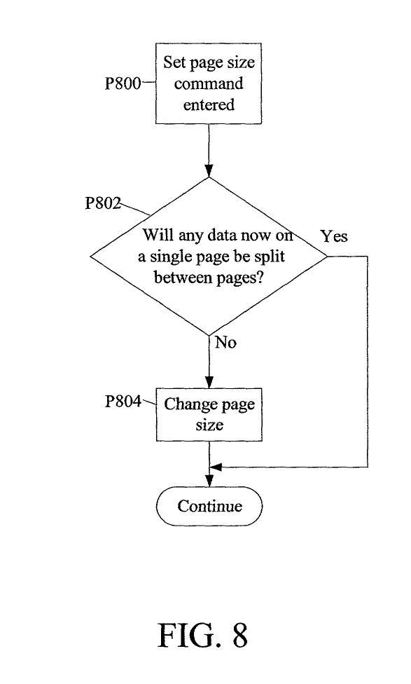

FIG. 8 is a flowchart that explains the processing for this aspect of the invention. At P800, a page size command is entered to resize the page. This may be accomplished by, for example, touching a page resizing icon on a display with a data input device, such as a pen input device, and touching one area of the display to indicate a new page length and another area of the screen to enter a new page width. Alternatively, via the data input device, a user may request, for example, a command entry screen by touching a specific portion of the display. When the command entry screen is displayed, the user may then enter a page size command, including the desired page length and width. Further, the user may bring up an options dialog box that has page controls for changing the width and height of a page. The page size may also be changed when changing the orientation of the device with hardware buttons, or a software user interface (UI). Further, in another alternative embodiment, any change in the size of the window can be treated as an attempt to resize the page.

Once the new page size information is entered, using this aspect of the invention, a determination is made as to whether the resizing of the page would cause any data that was previously entered on a single page to be split between two or more pages or whether any data would become clipped or hidden. If the previously entered data would be split between two or more pages or would become clipped or hidden, then the page size is not changed. Otherwise, at P804, the page size is changed.

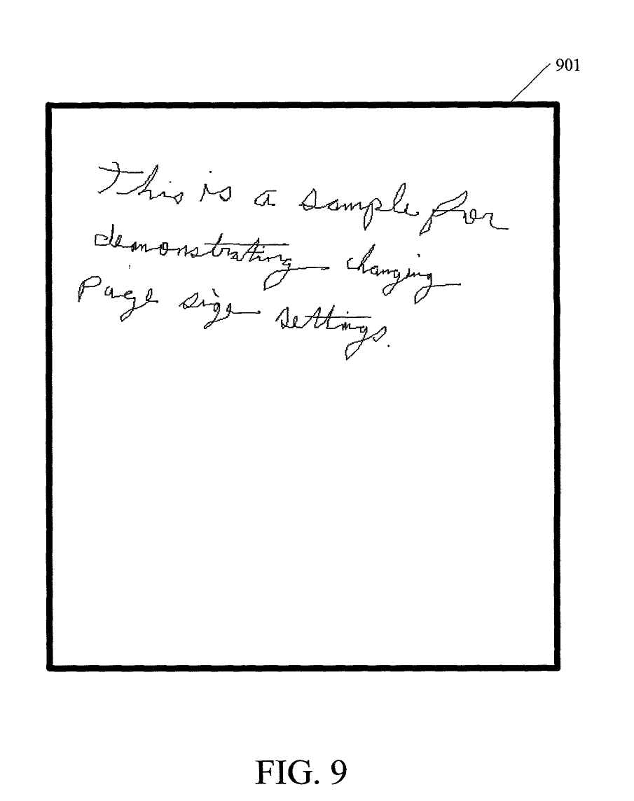

FIGS. 9-12 provide examples to demonstrate these aspects. In FIG. 9, a display is shown with existing data entered as electronic ink. The thick lines 901 encompassing the data show both the area of the electronic page and the available display area for data entry.

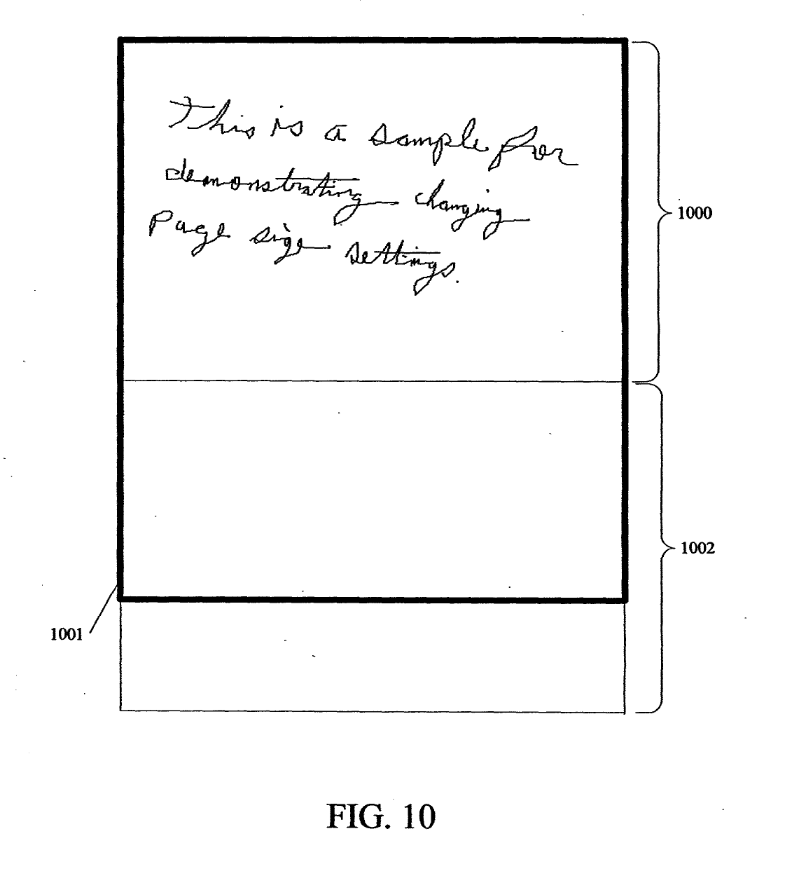

In FIG. 10, the thick lines 1001 encompass the available display area for data entry. Area 1000, including the area surrounded on three sides by thick lines and on one side by a thin line, represents the new page size. Area 1002 represents the next page. Because no previously entered data would be split between pages, resizing of the page is allowed.

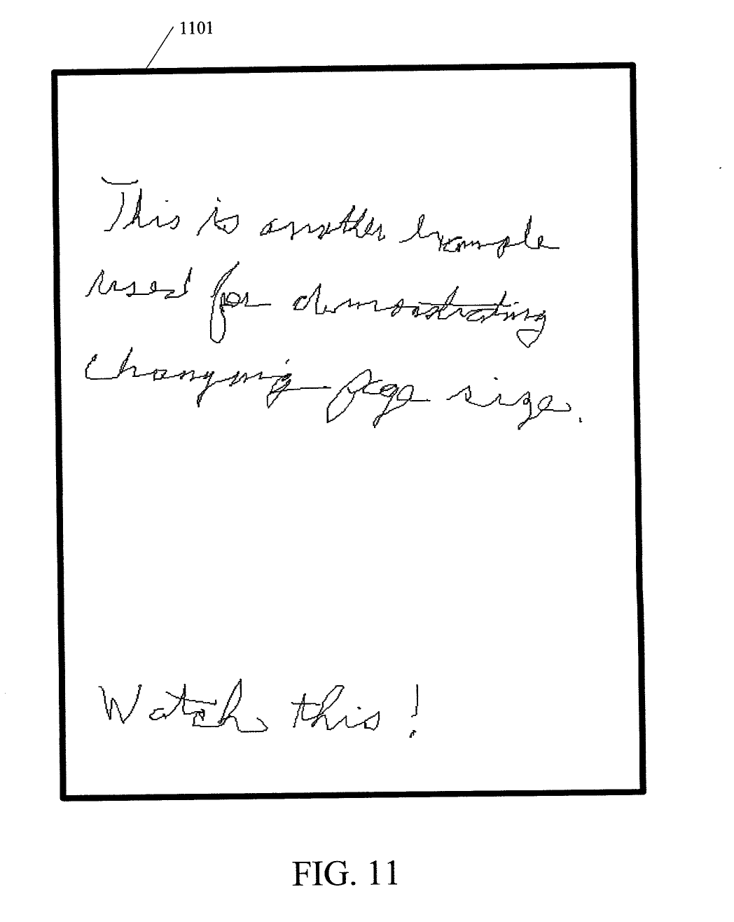

FIG. 11 shows an electronic page in which the thick lines 1101 encompassing the data (electronic ink) show both the area of the electronic page and the available display area for data entry.

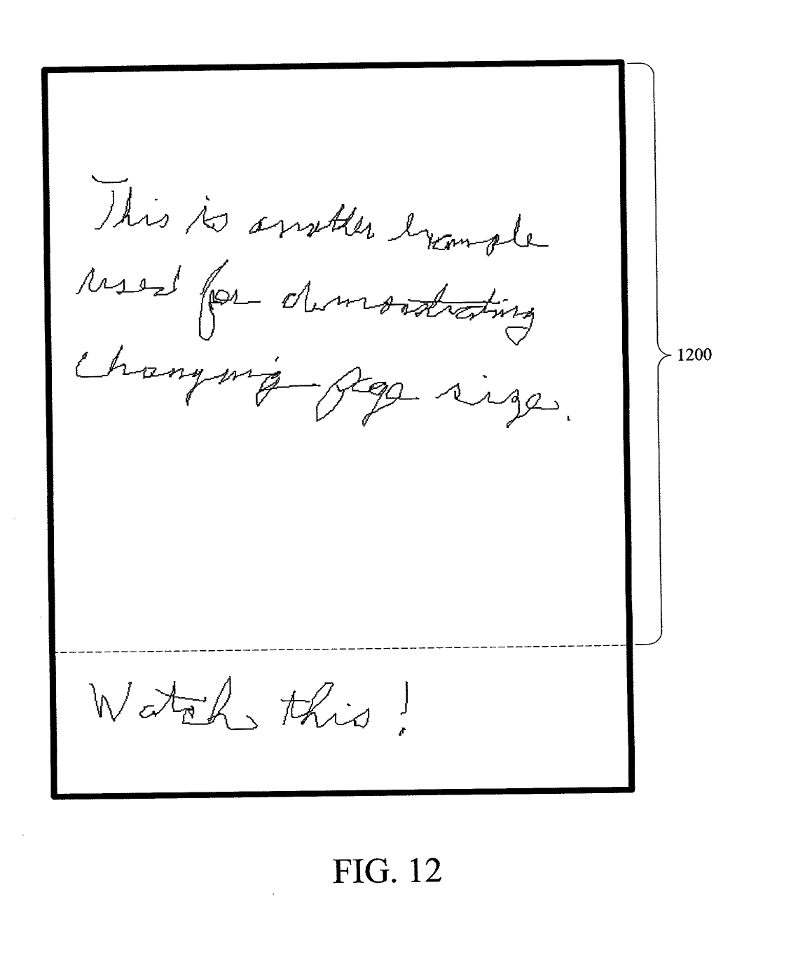

FIG. 12 shows the same electronic ink data as in FIG. 11, however, area 1200, the area surrounded on three sides by thick lines and on one side by a dashed line, represents the requested page size. Because changing the size of the page would cause previously entered data to be split among more than one page, the page size is not changed.

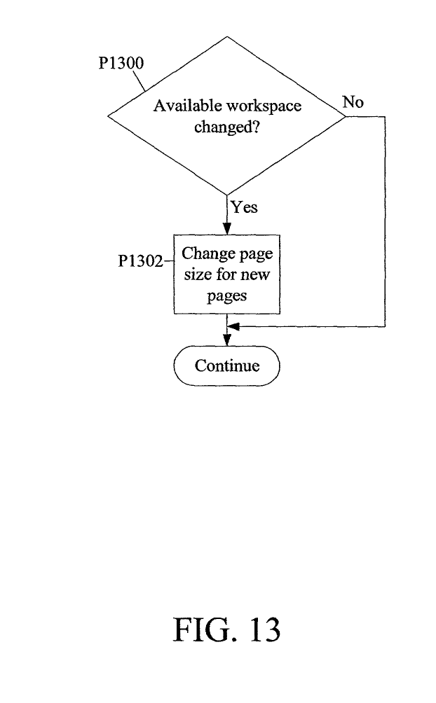

In yet another aspect of the invention, once the page size is set, as described previously, the page size of new pages may be set based on a changed amount of available workspace, while leaving unchanged the page size of existing application pages. For example, if the area taken up by application window adornments, such as tool bars or menus changes, the page size for new pages may be set to take into account the changed amount of available workspace, while leaving the size of already existing pages unchanged. FIG. 13 is a flowchart which helps to explain this embodiment of the invention.

At P1300, a check is performed to determine whether there has been a change in available workspace for electronic ink input. If so, at P1302 the page size for new pages is determined by performing the calculations described previously, and the new page size will be set for newly created pages, while leaving unchanged the page size for existing pages. Alternatively, the page size for existing pages may also be changed provided that a check be performed to prevent the new page size from being set for existing pages if the new page size would cause already entered data to be split among multiple pages or clipped or hidden.

Alternatively, when a new page is created, the space available to the application can be determined, as described above, and the page size for the new page can be set according to the current amount of available space, while leaving unchanged the page size of existing pages. In this alternative aspect of the invention, there is no need to perform the check at P1300.

In a further aspect of the invention, when creating a new document or file, the page size determination may be delayed until a user actually begins to enter data into the file or document. Thus any changes to the available workspace would be taken into account when setting the page size at the time that the user begins to enter data.

Embodiments of the invention may be implemented in hardware, software, firmware or by an application specific integrated circuit (ASIC). The firmware may be in a read only memory and the software may reside on a medium, such as read only memory, random access memory, floppy disk or compact disk.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A method of automatically setting a page size for an application based on a size of a display, comprising the steps of:
determining an amount of work area on the display that is available to the application for data input; and
setting the page size based on the available amount of work area.

2. The method of claim 1, wherein the determining step comprises:
determining a size of an application work area of the display, and
subtracting a size of an area used for application window adornments from the size of the application work area of the display to determine the amount of work area on the display that is available to the application for data input.

3. The method of claim 2, wherein the subtracting step comprises:
determining whether a display region of a text input system is visible and when the display region is determined to be visible, performing the steps of:
determining a size of an area of the display region, and
adding the size of the area of the display region to the size of the application work area of the display to determine the amount of work area on the display that is available to the application for data input.

4. The method of claim 1, wherein the available amount of work area is based on a size of a maximized application window.

5. The method of claim 1, wherein the available amount of work area is based on a size of a non-maximized application window.

6. The method of claim 1, wherein the application is an electronic ink application and the method of automatically setting the page size is delayed until a user begins to enter data using the application.

7. The method of claim 2, wherein the subtracting step further comprises:
subtracting a size of a scrolling element from the size of the application work area of the display to determine the amount of work area on the display that is available to the application for data input.

8. The method of claim 7, wherein the scrolling element is a vertical scroll bar.

9. The method of claim 1, further comprising:
automatically resizing the application page when the available amount of work area changes and data on each page remains on a same page, remains unclipped or remains unhidden.

10. The method of claim 1, further comprising the step of:
when the available amount of work area changes, setting a page size of new pages based on the changed available amount of work area, while leaving unchanged the page size of existing pages.

11. A device to automatically set a page size for an application based on a size of a display, comprising:
a work area determiner for determining a size of a work area of the display; and
an application page size setter to set a page size based on the available amount of the work area.

12. The device of claim 11, further comprising:
a subtractor for subtracting a size of an area used for application window adornments from the size of the work area of the display to determine an amount of work area on the display that is available to the application for data input.

13. The device of claim 12, wherein the subtractor further is for determining whether a display portion of a text input system is visible and when the display portion is determined to be visible, for determining a size of an area of the text input system and for adding the size of the area of the display portion to the size of the application work area of the display to determine the amount of work area on the display that is available to the application for data input.

14. The device of claim 11, wherein the page size is determined based on a size of a maximized application window.

15. The device of claim 11, wherein the page size is determined based on a size of a non-maximized application window.

16. The device of claim 12, further comprising:
a second subtractor for subtracting a size of a scrolling element from the updated size of the work area to determine the page size.

17. The device of claim 16, wherein the scrolling element is a vertical scroll bar.

18. A medium having machine-readable instructions recorded thereon, such that when the instructions are executed by a processor, the instructions cause the processor to perform the steps of:
determining an amount of work area on a display that is available to an application for data input; and
setting a page size based on the available amount of work area.

19. The medium of claim 18, wherein the determining step comprises the steps of:
determining a size of an application work area of the display, and
subtracting a size of an area used for application window adornments from the size of an application work area of the display to determine the amount of work area on the display that is available to the application for data input.

20. The medium of claim 19, wherein the subtracting step comprises:
determining whether a display portion of a text input system is visible and when the display portion is determined to be visible, performing the steps of:
determining a size of an area of the display portion of the text input system,
adding the size of the area of the display portion of the text input system to the size of the application work area of the display to determine the amount of work area on the display that is available to the application for data input.

21. The medium of claim 18, wherein the available amount of work area is based on a size of a maximized application window.

22. The medium of claim 18, wherein the available amount of work area is based on a size of a non-maximized application window.

23. The medium of claim 18, wherein the determining step and the setting step are delayed until after a user begins to enter data using an electronic ink application.

24. The medium of claim 19, wherein the medium further has instructions recorded therein to cause the processor to perform:
subtracting a size of a scrolling element from the size of the application work area of the display to determine the amount of work area on the display that is available to the application for data input.

25. The medium of claim 24, wherein the scrolling element is a vertical scroll bar.

26. The medium of claim 18, further comprising instructions to cause the processor to perform automatically resizing the application page when the available amount of work area changes and data on each page remains on a same page, remains unclipped or remains unhidden.

27. The medium of claim 18, further comprising instructions, such that when the instructions are executed by the processor and when the available amount of work area changes, page sizes of new pages are set based on the changed available workspace, while leaving unchanged the page size of existing application pages.
